(19) United States
(12) Patent Application Publication
(10) Pub. No.: US 2013/0042248 A1
(43) Pub. Date: Feb. 14, 2013

(54) SYSTEM AND METHOD FOR SUPPORTING PARALLEL THREADS IN A MULTIPROCESSOR ENVIRONMENT

(71) Applicant: Norman S. GARGASH, Boulder, CO (US)

(72) Inventor: Norman S. GARGASH, Boulder, CO (US)

(21) Appl. No.: 13/221,671

(22) Filed: Aug. 30, 2011

Related U.S. Application Data
(60) Provisional application No. 61/522,528, filed on Aug. 11, 2011.

(51) Int. Cl. G06F 9/46

(52) U.S. Cl. 718/102

(57) ABSTRACT

A method and system for supporting parallel processing of threads includes receiving a read request for a container from one or more read threads. Next, parallel read access to the container for each read thread may be controlled with a manager module that is coupled to the container. The manager module may receive a mutating request for the container from one or more mutating threads. While other read threads may be accessing the container, the manager module may provide single mutating access to the container in a series. The manager may monitor a reference count in the collection barrier for tracking a number of threads (whether read and/or mutating threads) which are accessing the collection barrier. The manager module may provide a mutex to a mutating thread for locking the container from any other mutating requests while permitting parallel read requests of the same container during the mutating operation.

### PRIORITY AND RELATED APPLICATIONS STATEMENT

This Application claims priority under 35 U.S.C. §119(e) to U.S. Provisional Patent Application Ser. No. 61/522,528, entitled, “SYSTEM AND METHOD FOR SUPPORTING PARALLEL THREADS IN A MULTIPROCESSOR ENVIRONMENT,” filed on Aug. 11, 2011. The entire contents of which are hereby incorporated by reference.

### DESCRIPTION OF THE RELATED ART

Multi-core processors are becoming the dominant use model in portable computing devices (“PCDs”), such as mobile telephones and lap top computers. Multi-core processors provide greater opportunities for parallelism in handling requests generated by software applications running on PCDs. However, there are problems with conventional software on PCDs which reduce and sometimes substantially eliminate any opportunity for parallelism.

One problem with software, and particularly, at the software application level includes protecting shared data containers with operating system (“O/S”) locks/mutexes. Locks and/or mutexes are designed to protect data but they may add considerable run-time overhead for multi-core processing systems. Locks and/or mutexes reduce the amount of parallelism that can be achieved in real world situations. The reason why is that a lock or a mutex prevents other threads from accessing a container in software when the container in software is “locked” with the mutex.

What is needed in the art is a method and system that relaxes locking constraints, makes the construction of lock-free data structures less demanding, and which provides data structures that are more useful for many practical problems faced by multi-core processing systems.

### SUMMARY OF THE DISCLOSURE

A method and system for supporting parallel processing of threads includes receiving a read request for a container from one or more read threads. Next, parallel read access to the container for each read thread may be controlled with a manager module that is coupled to the container. The manager module may receive a mutating request for the container from one or more mutating threads. While other read threads may be accessing the container, the manager module may provide single mutating access to the container in a series. The manager may monitor a reference count in the collection barrier for tracking a number of threads (whether read and/or mutating threads) which are accessing the collection barrier. The manager module may provide a mutex to a mutating thread for locking the container from any other mutating requests while permitting parallel read requests of the same container during the mutating operation.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a first aspect of a portable computing device (PCD);

FIG. 1B is a block diagram of application programs in memory of the PCD that include parallel read serial modify (“PRSM”) system modules;

FIG. 1C is a block diagram of an application program residing on a central processing unit (“CPU”) of the PCD and which has a PRSM system module;

FIG. 1D is a block diagram of two PRSM system modules for an application program of a PCD;

FIG. 2A is block diagram of PRSM manager that is part of a PRSM system module;

FIG. 2B is a block diagram of a collection barrier that may be part of each PRSM module of FIG. 1D.;

FIG. 3 is a flowchart illustrating a method for accessing a container to conduct a read operation;

FIG. 4 is a flowchart illustrating a method locking and unlocking a container to conduct a mutation of the container; and

FIG. 5 is a block diagram illustrating parallel read operations and serial modification operations of a single container of the inventive system.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities. Therefore, a wireless device could be a cellular telephone, a pager, a PDA, a smartphone, a navigation device, or a hand-held computer with a wireless connection or link.

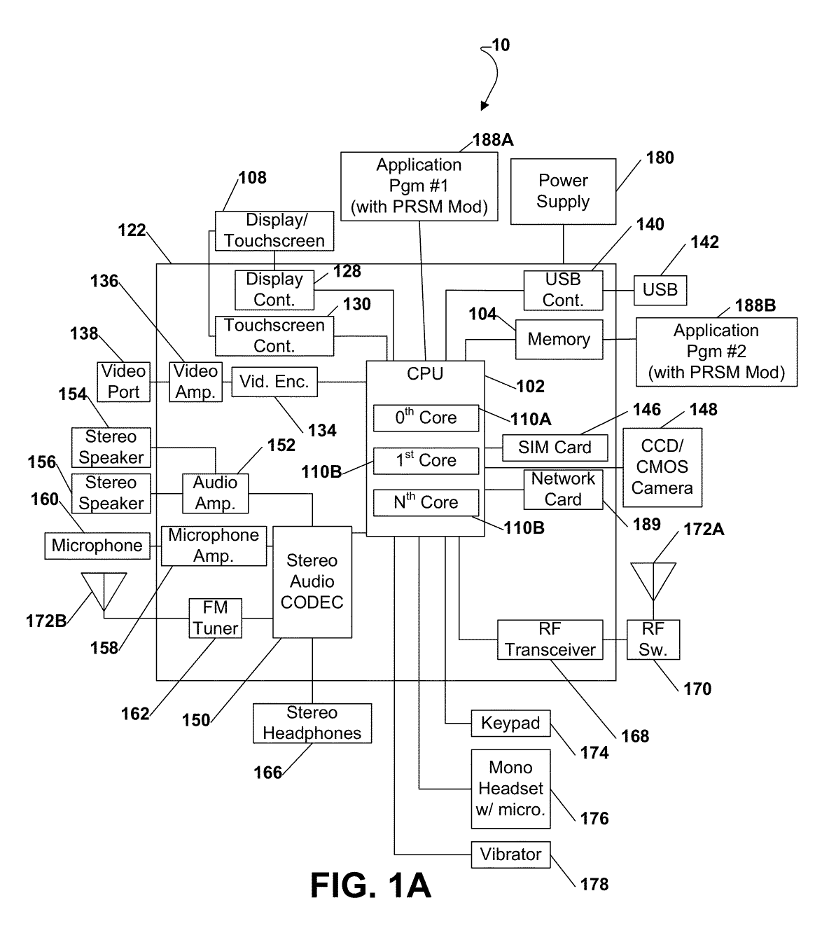

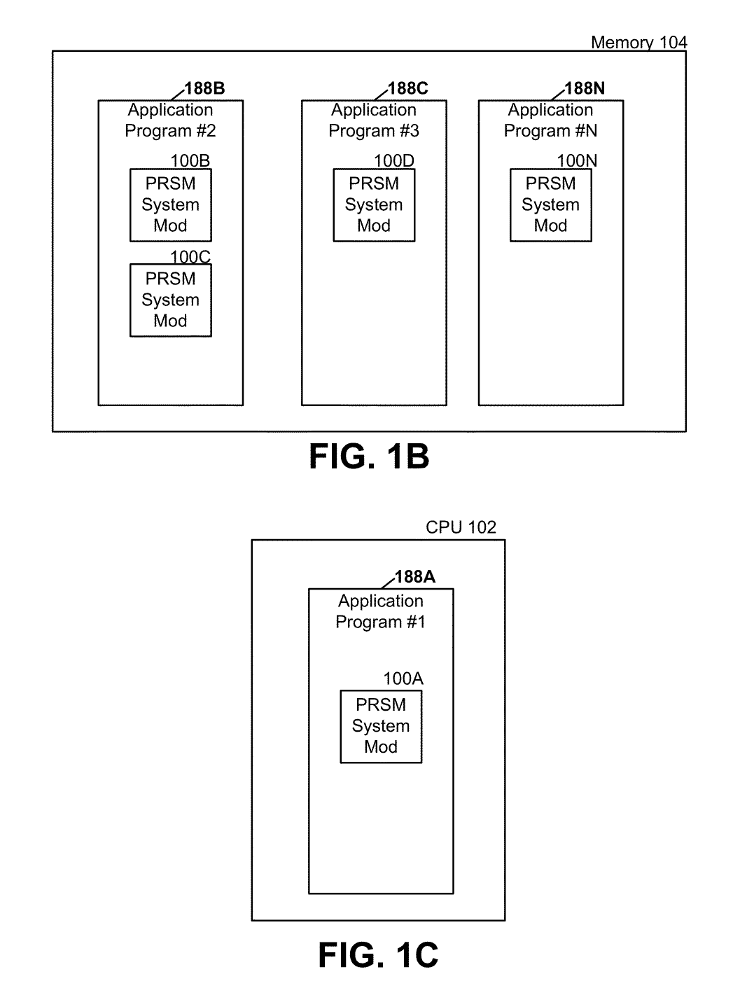

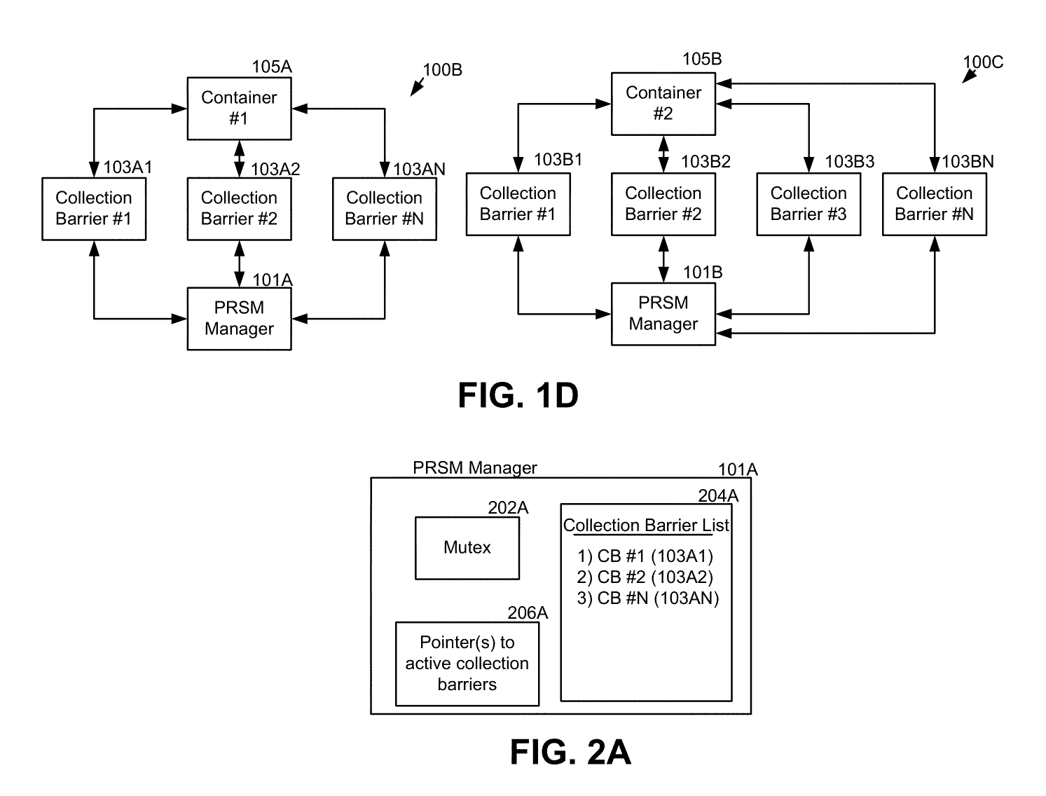

Referring initially to FIG. 1A, an exemplary, non-limiting aspect of a portable computing device (PCD) is shown and is generally designated 10. As shown, the PCD 10 includes an on-chip system 122 that includes a multi-core CPU 102. The multi-core CPU 102 may include a zeroth core 110A, a first core 110B, and an Nth core 110C. While the exemplary embodiment of FIG. 1A illustrates a multicore environment, the system and method are not limited to a multicore environment. In a single core environment, the system and method may reduce the number of lock accesses that may be required which is advantageous as understood by one of ordinary skill in the art.

As illustrated in FIG. 1A, a display controller 128 and a touch screen controller 130 are coupled to the multi-core CPU 102. In turn, a touch screen display 108 external to the on-chip system 122 is coupled to the display controller 128 and the touch screen controller 130.

FIG. 1A further illustrates a video encoder 134, e.g., a phase alternating line (PAL) encoder, a sequential color a memoire (SECAM) encoder, or a national television system(s) committee (NTSC) encoder, are coupled to the multi-core CPU 402. Further, a video amplifier 136 is coupled to the video encoder 134 and the touch screen display 108. Also, a video port 138 is coupled to the video amplifier 136. As depicted in FIG. 1A, a universal serial bus (USB) controller 140 is coupled to the multi-core CPU 102. Also, a USB port 142 is coupled to the USB controller 140. A memory 104 and a subscriber identity module (SIM) card 146 may also be coupled to the multi-core CPU 402. Further, as shown in FIG. 1A, a digital camera 148 may be coupled to the multi-core CPU 402. In an exemplary aspect, the digital camera 148 is a charge-coupled device (CCD) camera or a complementary metal-oxide semiconductor (CMOS) camera.

As further illustrated in FIG. 1A, a stereo audio CODEC 150 may be coupled to the multi-core CPU 102. Moreover, an audio amplifier 152 may coupled to the stereo audio CODEC 150. In an exemplary aspect, a first stereo speaker 154 and a second stereo speaker 156 are coupled to the audio amplifier 152. FIG. 1A shows that a microphone amplifier 158 may be also coupled to the stereo audio CODEC 150. Additionally, a microphone 160 may be coupled to the microphone amplifier 158. In a particular aspect, a frequency modulation (FM) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1A further indicates that a radio frequency (RF) transceiver 168 may be coupled to the multi-core CPU 402. An RF switch 170 may be coupled to the RF transceiver 168 and an RF antenna 172. As shown in FIG. 1A, a keypad 174 may be coupled to the multi-core CPU 402. Also, a mono headset with a microphone 176 may be coupled to the multi-core CPU 402. Further, a vibrator device 178 may be coupled to the multi-core CPU 402. FIG. 1A also shows that a power supply 180 may be coupled to the on-chip system 122. In a particular aspect, the power supply 180 is a direct current (DC) power supply that provides power to the various components of the PCD 10 that require power. Further, in a particular aspect, the power supply is a rechargeable DC battery or a DC power supply that is derived from an alternating current (AC) to DC transformer that is connected to an AC power source.

FIG. 1A further illustrates that the PCD 10 may also include a network card 188 that may be used to access a data network, e.g., a local area network, a personal area network, or any other network. The network card 188 may be a Bluetooth network card, a WiFi network card, a personal area network (PAN) card, a personal area network ultra-low-power technology (PeANUT) network card, or any other network card well known in the art. Further, the network card 188 may be incorporated into a chip, i.e., the network card 188 may be a full solution in a chip, and may not be a separate network card 188.

As depicted in FIG. 1A, the touch screen display 108, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, and the power supply 180 are external to the on-chip system 122.

In a particular aspect, one or more of the method steps described herein may be stored in the memory 104 as computer program instructions taking the form of application programs 188A and 188B. The application programs 188 may include parallel read serial modify (“PRSM”) system modules as will be described in further detail below.

These instructions in memory 104 may be executed by the multi-core CPU 102 in order to perform the methods described herein. Further, the multi-core CPU 102, the memory 104, or a combination thereof may serve as a means for executing one or more of the method steps described herein in order to manipulate data within a central processing unit 102.

FIG. 1B is a block diagram of application programs 188 in memory 104 of the PCD 10 that include parallel read serial modify (“PRSM”) system modules 100. As illustrated in FIG. 1B, three application programs 188B, 188C, 188N each include PRSM system modules 100. Specifically, the application program 188B on the far left of the diagram has at least two PRSM system modules 100B, 100C, while the two remaining application programs 188C, 188N each have a single PRSM system module 100D, 100N. One of ordinary skill the art will appreciate that each application program 188 will typically comprise a plurality of PRSM system modules 100. Each PRSM system module 100 has several components which will be described below in connection with FIG. 1D.

FIG. 1C is a block diagram of an application program 188A residing on a central processing unit (“CPU”) 102 of the PCD and which has a single PRSM system module 100A. This application program 188A may reside in cache memory that may be part of the central processing unit 102. As noted previously, each application program 188 may comprise a plurality of PRSM system modules 100 as appropriate for handling threads of execution generated by an application program 188.

The application programs 188 may comprise programs of any type as understood by one of ordinary skill in the art. For example, the application programs 188 may include, but are not limited to, e-mail programs, word processing programs, accounting/spreadsheet programs, Internet browser programs, search engine programs, calendar programs, workflow management programs, PCD performance monitoring programs, and other like application programs.

FIG. 1D is a block diagram of two PRSM system modules 100B, 100C for an application program 188B of a PCD 10. Specifically, these two PRSM modules 100B, 100C are the two illustrated in the application program 188B as illustrated in FIG. 1B.

Each PRSM module 100 comprises a PRSM manager 101, a collection barrier 103, and a container 105. A container 105 is a data structure whose instances are usually collections of other objects. Containers 105 are typically used for storing objects in an organized fashion and which may follow specific access rules. Containers are usually accessed by threads of an application program 188.

As understood by one of ordinary skill in the art, a thread is one of the smallest units of computer processing that can be scheduled by an operating system (“O/S”). It generally results from a fork of an application program 188 into two or more concurrently running tasks. The implementation of threads and processes may differ from one O/S to another, but in most cases, a thread is contained inside a process. Multiple threads can exist within the same process and share resources such as memory 104, while different processes do not share these resources. In particular, the threads of a process share the latter's instructions (its code) and some context (the values that its variables reference at any given moment). In other words, some variables may be shared between threads, but some variables may have values that are thread-specific as understood by one of ordinary skill in the art.

A container 105 may support data used in an application program 100 and accessed by threads. Threads may comprise read threads and mutating threads. Read threads only access containers 105 for reading the contents of the container 105. Meanwhile, mutating threads access containers 105 for changing the contents of the containers 105.

As an elementary example of a container 105 in an application program 188, suppose the application program 188B of FIG. 1B comprises an e-mail program. Then the container 105A of the PRSM system module 100B may support the data used for an e-mail in-box.

Each collection barrier 103 of a PRSM system module 100 may comprise a data structure that is created and tracked by the PRSM manager 101 for identifying which data in a container that is to be deleted by the PRSM manager 101. The collection barrier 103 may also be referred to as a garbage collection barrier as understood by one of ordinary skill in the art. A collection barrier is usually created by the PRSM manager 101 when a mutating thread desires to change the contents of a container 105.

A mutating thread may change a container 105 by deleting data or information from the container or it may add data or insert information into the container 105. In some exemplary embodiments, a mutating thread for inserting or adding data to a container 105 may cause the PRSM manager 101 to create a collection barrier 103 that does not contain information. In other exemplary embodiments, a mutating thread for inserting or adding data to a container 105 will not cause the PRSM manager 101 to create a container 105.

Each PRSM system module 100 may comprise a plurality of collection barriers 103. The first PRSM system module 100B of FIG. 1D has three collection barriers 103A1, 103A2, and 103AN corresponding to a first container 105A. Additional collection barriers 103 for the first container 105A may be created by the PRSM manager 101A beyond the ones illustrated in the FIG. 1D.

The second PRSM system module 100C of FIG. 1D has four collection barriers 103B1, 103B2, 103B3, and 103BN corresponding to the second container 105B. Like the first container 105A, it is noted that additional (or fewer) collection barriers 103 for the second container 105B may be created by the PRSM manager 101B beyond the ones illustrated in the FIG. 1D.

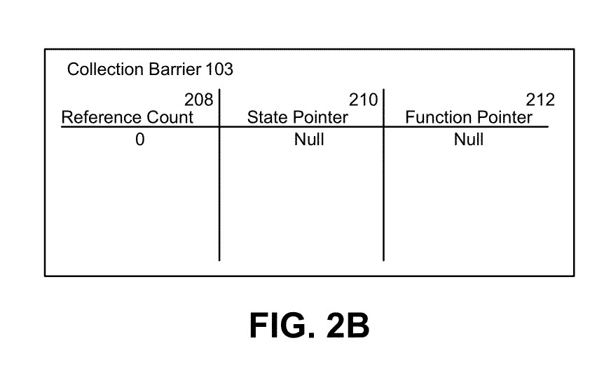

FIG. 2A is block diagram of PRSM manager 101A that is part of a PRSM module 100. The PRSM manager 101A is responsible for managing parallel reads of its corresponding container 105A from reading threads. The PRSM manager 101A is also responsible for serializing mutations requested by mutating threads. Mutations may include deletions from the container 105A as well as additions/insertions into the container 105A.

The PRSM manager 101 may comprise a mutex 202A, a collection barrier list 204A, and a listing of pointers 206A that reference active collection barriers 103 within the PRSM system module 100. A mutex 202, as understood by one of ordinary skill the art, is a mutual exclusion object that allows for multiple threads for sharing the same resource. A mutex 202 can be locked or unlocked by a mutating thread which makes requests to the PRSM manager 101.

The collection barrier list 204A of the PRSM manager 101A maintains references to deleted objects contained within the collection barriers 103A1, 103A2, and 103AN. Usually, the PRSM manager maintains this collection barrier list 204A in a first-in first-out (“FIFO”) order. In the exemplary embodiment illustrated in FIG. 2A, the collection barrier list 204A includes the three containers 103A1, 103A2, 103AN illustrated in FIG. 1D

Meanwhile, the pointers list 206A keeps track of a reference count for the PRSM manager 101A. That is, the PRSM manager 101A increments a reference count stored in the pointers list 206A and returns the pointer to a read thread that has requested a read lock. When the read thread completes the read, it unlocks by returning the pointer to the collection barrier 103 it was given in the lock. The PRSM manager 101A then decrements (decreases) the reference count on that lock which is tracked in the pointers list 206A.

This tracking with the pointers list 206A by the PRSM manager 101A keeps the manager 101A from having to allocate any additional memory on the read path—all the allocated memory happens on the mutate path and the system 100 can scale to an arbitrary number of read threads.

The pointers list module 206A usually tracks singly-linked list container types as understood by one of ordinary skill the art. All the collection barriers 103 associated a particular container 105/PRSM instance 101 refer to the same underlying container 105, and they define different versions of that container. As a container 105 is modified, new collection barriers 103 may be added that represent the new version of the container 105. Read threads are usually incrementing the collection barrier count maintained by the pointers list 206A, which means that the container 105 is being referenced in the old state even though the data container 105 is in the new state. Until all possible references to the old state are completed (when, in such a case, the reference count in the pointers list 206A will drop to zero—0—), any deleted data managed by the containers 103 cannot be reclaimed.

As noted above, collection barriers 103 usually only track deleted objects. But in some exemplary embodiments of the system 100, collection barriers 103 may be generated for additions (new objects) as well for deleted objects. While new containers 103 for new objects may add extra memory allocations, such an exemplary embodiment allows full versioning of the underlying container 103. Having full versioning of a container 103 available may be useful to read threads, as it may allow them to know that the container 103 was modified from when they started accessing it.

Code that uses a lock for a container usually does not access a container 105 directly nor the collection barriers 103 directly. When a read thread “locks”, it uses the collection barrier 103 that corresponds to the most current version of the container 105 while a mutating thread may add a new collection barrier 103 to indicate that the container 105 has been modified.

The collection barrier list 204A may represent discrete moments in time. A first read thread 1 begins and “locks” which increments the count in the pointers list 206A associated with the most recent collection barrier 103/the most current state of the container 105 (call this container state A). In parallel with a read thread, a mutating thread may delete an object from the container 105 which adds a new collection barrier 103, indicating that first—that the container 105 has changed and second—that collection barrier 103 contains references (a data pointer and a delete function) to what needs to be collected when that deleted element from the container 105 can no longer be referenced. This new collection barrier 103 represents a second container state B.

The new collection barrier 103 is later than the old collection barrier which has a non-zero reference count tracked by the pointers list 206A. This means that a thread is still accessing the container in state A, so the data that was removed when moving to state B must remain valid.

When the read thread completes its read function, it “unlocks” the container 105, which decrements the reference count tracked by the pointers list 206A associated with first container state A. The count in the pointers list 206A drops to a zero value (0), which means that no threads are referencing the container 105 in the first state A anymore. This means that the container 105 may be fully moved to the second state B and the data associated with state A may be reclaimed (deleted). One of ordinary skill in the art recognizes that other combinations and permutations of the singly-linked list model for the pointers 206A of PRSM module 101A are possible and are within the scope of the disclosure.

The read threads usually do not directly access the collection barrier list 204A. They are usually are “locking”/“unlocking” which comprises incrementing or decrementing the reference counts in the pointers list 206A associated with the barriers 103, but they are not directly looking/reviewing at the barriers 103. The direct manipulation of those barriers 103 is usually performed by the PRSM manager 101. In other words, the PRSM manager 101 accesses the barriers 103 while it is executing a read or mutating thread, but the user code in a particular thread is usually not directly accessing the collection barriers 103.

FIG. 2B is a block diagram of a collection barrier 103 that may be part of each PRSM module 100 illustrated in FIG. 1D. Each collection barrier 103 may comprise a reference count 208, a state pointer 210, and the function pointer 212. The reference count 208 lists the count of threads that are currently accessing a corresponding container 105. The state pointer 210 tracks the extraneous data or information that has been deleted from a container 105. The function pointer 212 identifies the function that will perform either a deletion or an addition to the container 105.

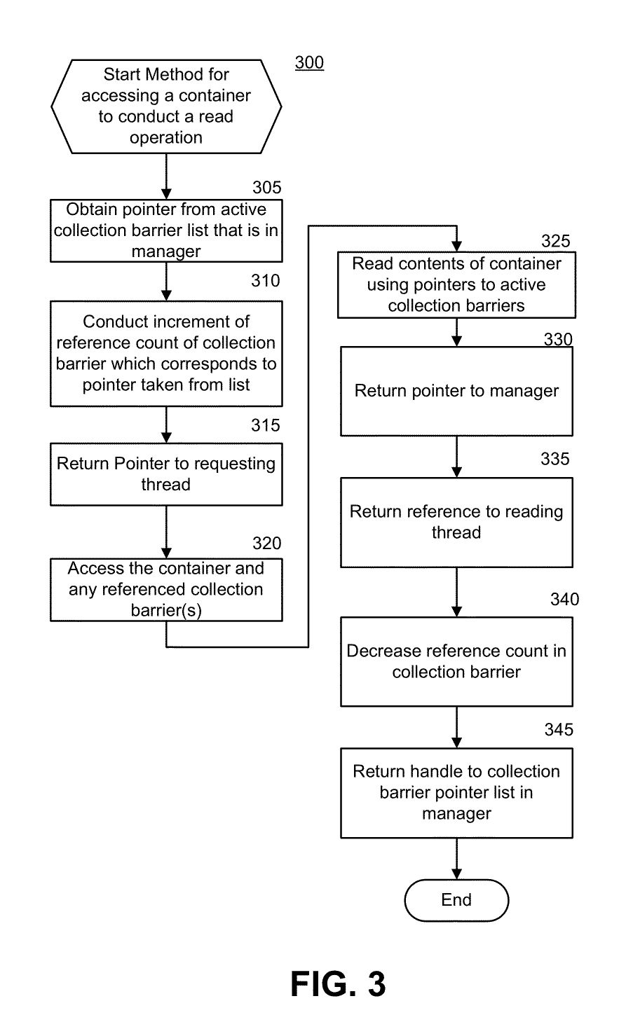

FIG. 3 is a flowchart illustrating a method 300 for accessing a container 105 to conduct a read operation. Block 305 is the first step of method 300. In block 305, a reading thread request the PRSM manager 101 to provide the pointer from the pointers list 206. From the pointers list 206, the PRSM manager 101 identifies the collection barriers 103 that the reading thread will need to access in order to conduct a full read of the container 105 and the corresponding collection barriers 103 which were created.

Next, in block 310, the PRSM manager 101 increases the reference count 208 of the collection barrier 103 which corresponds to the current state of the container. In block 315, the PRSM manager 101 returns the pointer to the requesting reading thread.

Subsequently, in block 320, the reading thread may access the container 105 and any corresponding collection barriers 103 as appropriate. In block 325, the reading thread may read the contents of the container 105 as well as any corresponding collection barriers 103 using the pointers list 206A of the PRSM manager 101.

Next, in block 330, the reading thread returns the pointer to the PRSM manager 101. The PRSM manager 101 returns the reference to the reading thread in block 335. In block 330, a reading thread does not actually know what it's getting a reference to, but internally, the reference is to the collection barrier 103 that represents the most current state of the container 105 at the earlier time that the read thread wishes to “lock” the container 105.

As noted previously, when a read thread requests a “lock” of the container 105 in block 305, the PRSM manager 101 determines the most recent collection barrier 103 in block 305, increments the reference count in the pointers list 206A for block 310, and then returns a reference to that collection barrier 103 to the thread requesting the lock in block 320. Then later, when that thread wishes to “unlock” the container 105, it returns back the reference to the PRSM manager 101 in block 330. The reference was given to the read thread when the read thread “locked” the container 105 in block 305.

The manager 101 then decrements the reference count in the pointers list 206A in block 340. Specifically, in block 340, the PRSM manager 101 decreases the reference count of the collection barrier 103 in order to indicate that the current reading thread is no longer accessing a container in the state represented by collection barrier 103. In this way, the PRSM manager 101 will know when a collection barrier 103 may be emptied of its “garbage” or deleted material since the reference count 208 keeps track of the number of threads (whether reading or mutating threads) are accessing a particular collection barrier 10. Since the read threads are responsible for keeping track of the reference, this approach enables there to be an arbitrary number of read threads without requiring the PRSM manager 101 to keep track of which threads are accessing the container 105.

The reference count 208 of each collection barrier 103 allows the PRSM manager 101 to know when data may be removed from a particular collection barrier 103 without causing any conflicts with other parallel reading or mutating threads who are accessing a container 105. Next, in block 345, the PRSM manager 101 returns the handle to the pointer list 206.

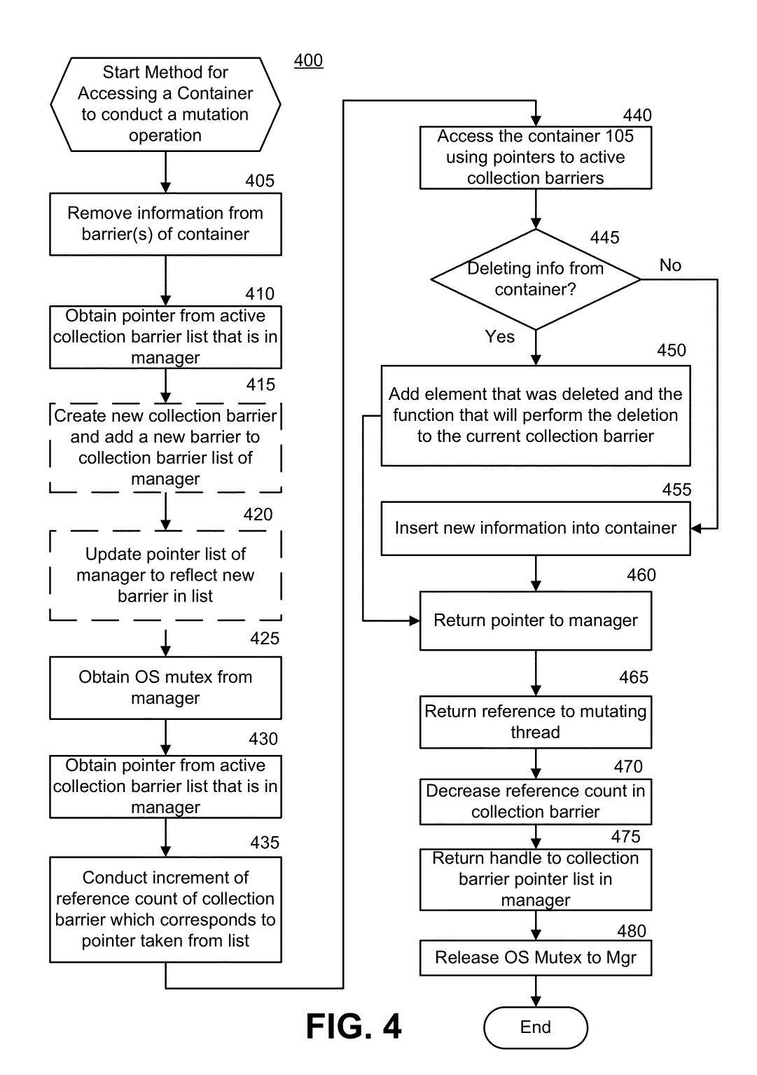

FIG. 4 is a flowchart illustrating a method 400 for locking and unlocking a container 105 to conduct a mutation of the container 105. A mutation may include a deletion and/or an addition to the container 105. Block 405 is the first step of method 400. In block 405, the PRSM manager 101 may remove information from one or more collection barriers 103 by checking the reference count 208 of each collection barrier 103 starting with the oldest. The PRSM manager 101 will only remove information from a collection barrier 103 if the reference count 208 has a zero value which indicates that no other thread is currently accessing the container 105 in the state represented by a particular collection barrier 103. If the reference count 208 has a nonzero value, then this indicates that the collection barrier 103 is being accessed by one or more threads. Once any referenced collection barrier 103 has been reached, that and all subsequent collection barriers 103 cannot be freed, as a thread may be accessing the container 105 which includes the state referred to by the collection barriers 103.

One of ordinary skill the art will appreciate that the removal of information in block 405 may also occur at the very end of method 400 such as after block 475. It is also possible to keep two removal blocks 405 as part of the method 400. Further, the PRSM manager 101 may also delete a collection barrier 103 after its contents have been removed.

When the PRSM manager 101 is ready to delete information from a particular collection barrier 103 and corresponding container 105, the PRSM manager 101 references the state pointer 210 of the collection barrier 103 to determine what information is to be deleted from a particular container 105. The PRSM manager 101 also reviews the function pointer 212 that identifies what function will perform the deletion from the container 105. Once the data is removed from the container 105, the PRSM manager 101 may remove the data from the collection barrier 103 and then delete the collection barrier 103.

Next, in block 410, a mutating thread requests the PRSM manager 101 to provide the pointer from the pointers list 206 of the PRSM manager. From the pointers list 206, the PRSM manager 101 identifies the collection barriers 103 that the mutating thread will need to access in order to conduct a full read of the container 105 and the corresponding collection barriers 103 which were created.

Next, in optional block 415, the PRSM manager 101 creates a new collection barrier 103 and adds this new barrier 103 to the collection barrier list 204A of FIG. 2A. Block 415 is optional if the mutating thread will be inserting or adding data to the container 105. In some exemplary embodiments, the PRSM system module 100 may be made more efficient if collection barriers 103 are not created for insertions of new data in a container 105. When containers 103 are created for insertions or additions of new data, each container 103 for such insertion or addition functions is not provided with any information. The contents of containers 103 are generally reserved for data which is to be removed or deleted from a container 105.

However, new collection barriers 103 are generally always created for mutating threads which plan to delete or remove data from a container 105. In these circumstances, each collection barrier 103 that is created by the PRSM manager 101 will be provided with the data which is to be removed from a particular container 105.

Next, in optional block 420, the pointer list 206 of PRSM manager 101 as illustrated in FIG. 2A is requested by the mutating thread to be updated by the PRSM manager 101 to reflect any new collection barriers 103 that were created in optional block 415. Block 420 is optional in the sense that this block is not practiced if a new collection barrier 103 is not created in block 415, such as when a mutating thread is adding new information to a container 105 and collection barriers creation function of block 415 is turned “off” according to an exemplary embodiment of the system module 100.

In block 425, the mutating thread obtains the OS mutex 202 from the PRSM manager 101. This block 425 locks out other mutating threads from accessing the container 105. However, other reading threads executing method 300 may still access the container 105 for performing a read operation of the container 105.

Next, in block 430, the mutating thread requests the PRSM manager 101 to provide the pointer from the pointers list 206 of the PRSM manager. From the pointers list 206, the PRSM manager 101 identifies the collection barriers 103, including the new collection barriers 103 that were created in block 415, that the mutating thread will need to access in order to conduct a full read of the container 105 and the corresponding collection barriers 103.

In block 435, the PRSM manager 101 increases the reference count 208 of the collection barrier 103 which corresponds to the current state of the container 105. Subsequently, in block 440, the mutating thread may access the container 105 and any corresponding collection barriers 103 as appropriate using the pointers list 206A of the PRSM manager 101.

In decision block 445, the PRSM manager 101 determines if the mutating thread is the deleting any information from the container 105. If the inquiry to decision block 445 is negative, then the “NO” branch is followed to block 455. If the inquiry to decision block 445 is positive, then the “YES” branch is followed to block 450.

In block 450, the PRSM manager 101 adds the element (data/information) requested by the mutating thread to be deleted from the container 105 in the state pointer 210 of the collection barrier 103 created for the current mutating thread. The mutating thread provides the PRSM manager 101 with the element to be deleted as well as the function for performing the deletion in the function pointer 212 of the collection barrier 103. From block 450, the method 400 continues on to block 460.

In block 455, a mutating thread which is only inserting or adding data to the container 105 will perform this operation in this block. Next, in block 460, the mutating thread returns the pointer to the PRSM manager 101. The PRSM manager 101 returns the reference to the mutating thread in block 465.

Next, in block 470, the PRSM manager 101 decreases the reference count 208 of the current collection barrier 103 in order to indicate that the current mutating thread is no longer accessing the container in the state represented by collection barrier 103. In this way, the PRSM manager 101 will know when a collection barrier 103 may be emptied of its “garbage” or deleted material since the reference count 208 keeps track of the number of threads (whether reading or mutating threads) are accessing a particular collection barrier 103.

As mentioned previously, the reference count 208 of each collection barrier 103 allows the PRSM manager 101 to know when data may be removed from a particular collection barrier 103 without causing any conflicts with other parallel reading or mutating threads who are accessing a container 105. Next, in block 475, the PRSM manager 101 returns the handle to the pointer list 206. In block 480, the mutating thread releases the OS mutex 202 to the PRSM manager 101. This block 480 frees up the container 105 so that a next, single mutating thread may access the container 105 for a modifying operation (insertion or deletion).

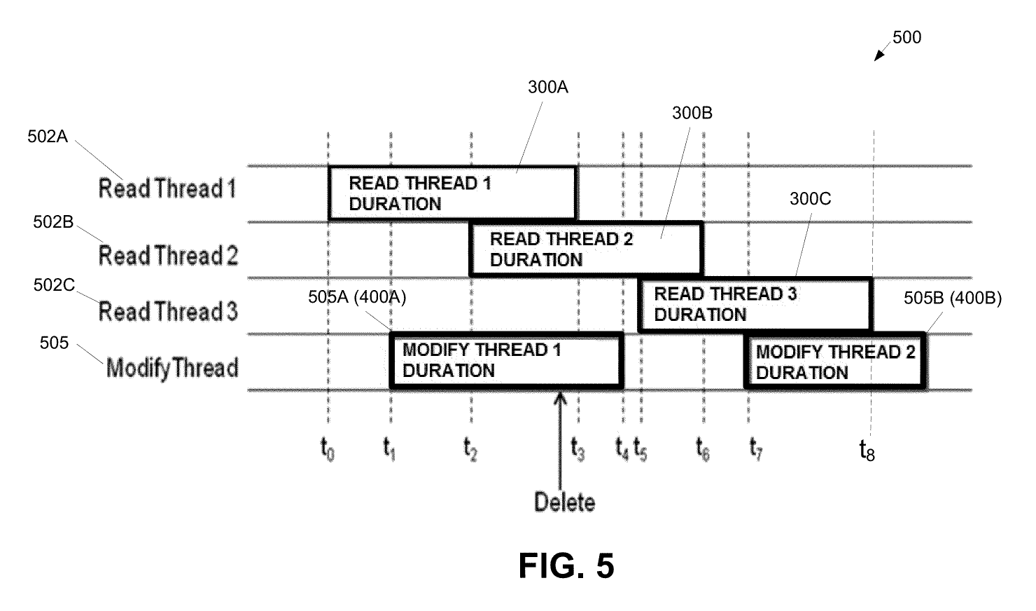

One of ordinary skill in the art will recognize that read method 300 and mutating method 400 may be executed in parallel or simultaneously. In other words, multiple read operations utilizing read method 300 may occur in parallel with a single mutating operation utilizing mutating method 400, such as illustrated in FIG. 5 describe below. This means that parallel read operations may occur in concert with single mutating operations. However, mutating operations may only occur in series and not in parallel.

FIG. 5 is a block diagram illustrating parallel read operations 300 and serial modification operations 400 of a single container 105 with the inventive system 100. As illustrated in FIG. 5, a first read thread 502A starts a read operation 300A of a container 105 at a time t0. Then a first modify or mutating thread 505A starts a modify or mutating operation 400A at time t1.

While the first thread 502A is reading the container 105 and while the first mutating thread 505A is changing the container 105, a second read thread 502B may start its own reading operation 300B at time t2. After the first thread 502A has completed its read operation 300A at time t3 and after the first mutating thread 505A has completed its mutating operation 400A at time t4, a third read thread 502C may start its reading operation 300C at time t5 while the second read thread 502B is still completing its reading operation 300B.

This means that the first and second read operations 300A, 300B have occurred in parallel with the first mutating operation 400A during the time period that spans between time t2 and t4. Similarly, the third read operation 300C has occurred in parallel with a second mutating operation 400B during the time period that stands between time t7 to t8.

The specific operations of the read threads 502 and the mutating threads 505 as they relate to the collection barriers 103 are summarized as follows and are described in connection with an exemplary embodiment such as illustrated in FIG. 1D, starting with only a single collection barrier #1 (103A1):

At time t0—a first read thread 1 (502A) accesses a first container 105A. The reference count 208 of first collection barrier #1 (103A1) is incremented->CB[0].count==1, as part of a first instance of method 300A which is executed (Block 310).

At time t1—a first mutating or modifying thread 1 (505A) accesses the first container 105A. A first instance of method 400A is executed in parallel with the first instance of method 300A. In block 405, the barrier list 204A is searched for deleted info (“garbage”) to be reclaimed—none available for this instance. The mutating thread obtains the mutex (Block 425) and the container 105A is locked against all other mutating threads, however, read threads may still have access to the container 105A. As part of the first instance of method 400A, reference count 208 of first collection barrier #1 (103A1) is incremented (Block 435)->CB[0].count==2.

At time t2—a second read thread 2 (502B) initiates a second instance of method 300B while the first instance of method 300A and first instance of method 400A are executing. The reference count 208 of first collection barrier #1 (103A1) is incremented ->CB[0].count==3, as part of a first instance of method 300A which is executed (Block 310).

At a moment in time just before time t3, the first mutating thread 1 (505A) initiates the deleting stage which includes blocks 415 and 420 of method 400—the creation of a second collection barrier #2 (103A2) in which the second collection barrier #2 (103A2) is added to the collection barrier list 204A of the PRSM manager 101A.

At time t3, the first read thread 1 (502A) has finished its read operation of the first container 105A. The reference count 208 of first collection barrier #1 (103A1) is decremented->CB[0].count==2, as part of a first instance of method 300A which is executed (Block 340).

At time t4, the first mutating thread 1 (505A) has finished its modifying operation. The reference count 208 of first collection barrier #1 (103A1) is decremented->CB[0].count==1, as part of a first instance of method 400A which is executed (Block 470). The first mutating thread 1 (505A) then releases the mutex 202A (Block 480) to the PRSM manager 101A.

At time t5, a third read thread 3 (502C) initiates a third instance of method 300C while the second instance of method 300B initiated by the second read thread 2 (502B) is running For the second instance of method 300B, the reference count 208 (not illustrated) of the second collection barrier #2 (103A2) is incremented->CB[1].count==1, as part of the second instance of method 300B which is executed (Block 310).

At time t6, the second read thread 2 (502B) finishes reading the container 105A. The reference count 208 of first collection barrier #1 (103A1) is decremented->CB[0].count==0, as part of a second instance of method 300B which is executed (Block 340). Since the reference count 208 of the first collection barrier #1 (103A1) is now at zero, no threads (whether mutating or reading) can access the element in this first collection barrier #1 (103A1). The element of the first container 105A referenced by the first collection barrier #1 (103A) may be deleted when a mutating thread accesses the container 105A, as described below.

At time t7, a second mutating or modify thread 2 (505B) accesses the container 105A. A second instance of method 400B is executed in parallel with the third instance of method 300C. In block 405, the barrier list 204A is searched for deleted info (“garbage”) to be reclaimed—there is some available as indicated by the reference count 208 of zero for the first collection barrier #1 (103A1). The information referenced by the first collection barrier #1 (103A1) is deleted from the first container 105A.

The second mutating thread 2 (505B) obtains the mutex (Block 425) and the container 105A is again locked against all other mutating threads, however, read threads may still have access to the container 105A. As part of the first instance of method 400A, reference count 208 of the second collection barrier #2 (103A2) is incremented (Block 435)->CB[1].count==2.

At time t8, the third read thread 3 (502C) ends its reading operation while the mutating operation of the second instance of method 400B by the second mutating thread 2 (505B) continues. The reference count 208 of the second collection barrier #2 (103A2) is decremented (Block 340)->CB[1].count==1.

Multiple different container types may be supported with the PRSM system 100 provided they are able to be modified atomically in a lock-free manner, which may require certain machine-specific atomic instructions such as ldrex/strex or compare-and-swap (“CAS”). As understood by one of ordinary skill in the art, LDREX/STREX comprise instructions designed to support multi-master systems, for example, systems with multiple cores or systems with other bus masters such as a direct memory access (“DMA”) controller. Their primary purpose is to maintain the integrity of shared data structures during inter-master communication by preventing two masters making conflicting accesses at the same time, i.e., synchronization of shared memory.

The container types described above comprise a singly-linked list type as understood by one of ordinary skill in the art. These atomic instructions may be supported by hardware such as Advanced Reduced instruction set Machines (“ARMs”). However, other hardware may be used as understood by one of ordinary skill in the art.

The PRSM system 100 may support other container types, such as, but not limited to, vector types, associative types, set types, order types, and doubly-linked list types as understood by one of ordinary skill in the art. The container types are usually a function of the primitives supported in software in a given portable computing device 10. In the software is easy governed by the type of hardware supplied in the portable computing device 10.

The PRSM system 100 provides a self balancing approach to parallel processing that may reduce hard limits or failure cases because the system 100 does not have a fixed set of collection barriers 103 for a particular container 105. The PRSM system 100 does not need to know how many threads will access a container 105. The system 100 allows reading threads to operate in parallel with all other reading threads and single mutating threads. Specifically, the PRSM system 100 permits parallel reading operations for a container 105 that may occur simultaneously with a single modifying or mutating operation. A mutating operation may add new data (information) to the container 105. Alternatively, a mutating operation may delete data (information) from the container 105. Such single mutating operations from a single mutating thread operate in parallel with a plurality of reading threads.

The PRSM system 100 supports sufficient parallel processing, especially in multi-core environments, because usually in most software applications, more reading operations generally occur with containers 105 compared to mutating operations the change data for containers 105.

The PRSM system 100 is ideal for multi-core processors since most multi-core processors usually have a set of instructions that will enable atomic-lock free operations for reference counting on one level or another. The methods 300, 400 and system 100 described above relax locking constraints, make the construction of lock-free data structures less demanding, and provide data structures that are useful for multi-core processing systems.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGs. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for supporting parallel processing of threads in a portable computing device, the method comprising:
receiving a read request for a container from one or more read threads;
controlling parallel read access to the container for each read thread with a manager module coupled to the container;
receiving a mutating request for the container from one or more mutating threads; and
providing single mutating access to the container for each mutating thread in a series with the manager module.

2. The method of claim 1, wherein the mutating request comprises at least one of a deletion operation and a insertion operation.

3. The method of claim 1, wherein the container comprises at least of a singly-list type, a vector type, an associative array type, a set type, and order type, and a doubly-linked list type.

4. The method of claim 1, further comprising:
creating a collection barrier for each mutating request.

5. The method of claim 4, further comprising:
monitoring a reference count in the collection barrier for tracking a number of threads accessing the collection barrier.

6. The method of claim 1, further comprising:
providing a mutex to a mutating thread for locking a container from any other mutating requests while permitting parallel read requests of the container.

7. The method of claim 1, further comprising:
tracking formation of collection barriers formed for each container with the manager module.

8. The method of claim 4, further comprising:
tracking information to be deleted with each collection barrier.

9. The method of claim 8, further comprising:
tracking a function that will perform a deletion operation on a container with each collection barrier.

10. The method of claim 6, further comprising:
receiving a mutex from a mutating thread in order to un-lock the container so that a subsequent single mutating thread may access the container.

11. A computer system for supporting parallel processing of threads in a portable computing device, the system comprising:
a processor operable for:
receiving a read request for a container from one or more read threads;
controlling parallel read access to the container for each read thread with a manager module coupled to the container;
receiving a mutating request for the container from one or more mutating threads; and
providing single mutating access to the container for each mutating thread in a series with the manager module.

12. The system of claim 11, wherein the mutating request comprises at least one of a deletion operation and a insertion operation.

13. The system of claim 11, wherein the container comprises at least of a singly-list type, a vector type, an associative type, a set type, and order type, and a doubly-linked list type.

14. The system of claim 11, wherein the processor operable for creating a collection barrier for each mutating request.

15. The system of claim 14, wherein the processor operable for monitoring a reference count in the collection barrier for tracking a number of threads accessing the collection barrier.

16. The system of claim 11, wherein the processor operable for providing a mutex to a mutating thread for locking the container from any other mutating requests while permitting parallel read requests of the container.

17. The system of claim 11, wherein the processor is further operable for tracking formation of collection barriers formed for each container with the manager module.

18. The system of claim 11, wherein the processor is further operable for tracking information to be deleted with each collection barrier.

19. The system of claim 18, wherein the processor is further operable for tracking a function that will perform a deletion operation on a container with each collection barrier.

20. The system of claim 16, wherein processor is further operable for receiving a mutex from a mutating thread in order to un-lock the container so that a subsequent single mutating thread may access the container.

21. A computer system for supporting parallel processing of threads in a portable computing device, the system comprising:
means for receiving a read request for a container from one or more read threads;
controlling parallel read access to the container for each read thread with a manager module coupled to the container;
means for receiving a mutating request for the container from one or more mutating threads; and
means for providing single mutating access to the container for each mutating thread in a series with the manager module.

22. The system of claim 21, wherein the mutating request comprises at least one of a deletion operation and a insertion operation.

23. The system of claim 21, wherein the container comprises at least of a singly-list type, a vector type, an associative type, a set type, and order type, and a doubly-linked list type.

24. The system of claim 21, further comprising:
means for creating a collection barrier for each mutating request.

25. The system of claim 24, further comprising:
means for monitoring a reference count in the collection barrier for tracking a number of threads accessing the collection barrier.

26. The system of claim 21, further comprising:
means for providing a mutex to a mutating thread for locking a container from any other mutating requests while permitting parallel read requests of the container.

27. The system of claim 21, further comprising:
means tracking formation of collection barriers formed for each container with the manager module.

28. The system of claim 24, further comprising:
means for tracking information to be deleted with each collection barrier.

29. The system of claim 28, further comprising:
means for tracking a function that will perform a deletion operation on a container with each collection barrier.

30. The system of claim 26, further comprising:
means for receiving a mutex from a mutating thread in order to un-lock the container so that a subsequent single mutating thread may access the container.

31. A computer program product comprising a computer usable medium having a computer readable program code embodied therein, said computer readable program code adapted to be executed to implement a method for or supporting parallel processing of threads in a portable computing device, said method comprising:
receiving a read request for a container from one or more read threads;
controlling parallel read access to the container for each read thread with a manager module coupled to the container;
receiving a mutating request for the container from one or more mutating threads; and
providing single mutating access to the container for each mutating thread in a series with the manager module.

32. The computer program product of claim 31, wherein the mutating request comprises at least one of a deletion operation and a insertion operation.

33. The computer program product of claim 31, wherein the container comprises at least of a singly-list type, a vector type, an associative type, a set type, and order type, and a doubly-linked list type.

34. The computer program product of claim 31, wherein the program code implementing the method further comprises:
creating a collection barrier for each mutating request.

35. The computer program product of claim 34, wherein the program code implementing the method further comprises:
monitoring a reference count in the collection barrier for tracking a number of threads accessing the collection barrier.

36. The computer program product of claim 31, wherein the program code implementing the method further comprises:
providing a mutex to a mutating thread for locking a container from any other mutating requests while permitting parallel read requests of the container.

37. The computer program product of claim 31, wherein the program code implementing the method further comprises:
tracking formation of collection barriers formed for each container with the manager module.

38. The computer program product of claim 34, wherein the program code implementing the method further comprises:
tracking information to be deleted with each collection barrier.

39. The computer program product of claim 38, wherein the program code implementing the method further comprises:
tracking a function that will perform a deletion operation on a container with each collection barrier.

40. The computer program product of claim 36, wherein the program code implementing the method further comprises:
receiving a mutex from a mutating thread in order to un-lock the container so that a subsequent single mutating thread may access the container.
